(19) United States
(12) Patent Application Publication
(10) Pub. No.: US 2024/0414805 A1
(43) Pub. Date: Dec. 12, 2024

(54) CELL DISCONTINUOUS RECEPTION OR DISCONTINUOUS TRANSMISSION FOR MULTIPLE TRANSMISSION RECEPTION POINTS

(71) Applicant: QUALCOMM Incorporated, San Diego, CA (US)

(72) Inventors: Ahmed Attia ABOTABL, San Diego, CA (US); Marwen ZORGUI, San Diego, CA (US); Wanshi CHEN, San Diego, CA (US)

(21) Appl. No.: 18/332,067

(22) Filed: Jun. 9, 2023

(51) Int. Cl. H04W 76/28; H04L 5/00

(52) U.S. Cl. CPC H04W 76/28; H04L 5/0035

(57) ABSTRACT

Various aspects of the present disclosure generally relate to wireless communication. In some aspects, a user equipment (UE) may receive configuration information indicating cell discontinuous reception (DRX) or discontinuous transmission (DTX) cycles for multiple transmission reception points (TRPs). The cell DRX or DTX cycles may indicate inactive times and active times for the multiple TRPs. The UE may communicate with one or more TRPs, of the multiple TRPs, in accordance with the cell DRX or DTX cycles. Numerous other aspects are described.

### INTRODUCTION

Aspects of the present disclosure generally relate to wireless communication and to techniques and apparatuses for cell discontinuous reception (DRX) and/or discontinuous transmission (DTX).

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various

telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed at a user equipment (UE). The method may include receiving configuration information indicating cell discontinuous reception (DRX) or discontinuous transmission (DTX) cycles for multiple transmission reception points (TRPs), the cell DRX or DTX cycles indicating inactive times and active times for the multiple TRPs. The method may include communicating with one or more TRPs, of the multiple TRPs, in accordance with the cell DRX or DTX cycles.

Some aspects described herein relate to a method of wireless communication performed at a network node. The method may include transmitting configuration information indicating cell DRX or DTX cycles for multiple TRPs, the cell DRX or DTX cycles indicating inactive times and active times for the multiple TRPs. The method may include communicating, via one or more TRPs of the multiple TRPs, in accordance with the cell DRX or DTX cycles.

Some aspects described herein relate to an apparatus for wireless communication at a UE. The apparatus may include one or more memories storing processor-executable code and one or more processors coupled with the one or more memories. The one or more processors may be individually or collectively operable to receive configuration information indicating cell DRX or DTX cycles for multiple TRPs, the cell DRX or DTX cycles indicating inactive times and active times for the multiple TRPs. The one or more processors may be individually or collectively operable to communicate with one or more TRPs, of the multiple TRPs, in accordance with the cell DRX or DTX cycles.

Some aspects described herein relate to an apparatus for wireless communication at a network node. The apparatus may include one or more memories and one or more processors coupled to the one or more memories. The one or more processors may be individually or collectively operable to transmit configuration information indicating cell DRX or DTX cycles for multiple TRPs, the cell DRX or DTX cycles indicating inactive times and active times for the multiple TRPs. The one or more processors may be individually or collectively operable to communicate, via one or more TRPs of the multiple TRPs, in accordance with the cell DRX or DTX cycles.

Some aspects described herein relate to a non-transitory computer-readable medium that stores a set of instructions for wireless communication by a UE. The set of instructions, when executed by one or more processors of the UE, may cause the UE to receive configuration information indicating cell DRX or DTX cycles for multiple TRPs, the cell DRX or DTX cycles indicating inactive times and active times for the multiple TRPs. The set of instructions, when executed by one or more processors of the UE, may cause the UE to communicate with one or more TRPs, of the multiple TRPs, in accordance with the cell DRX or DTX cycles.

Some aspects described herein relate to a non-transitory computer-readable medium that stores a set of instructions for wireless communication by a network node. The set of instructions, when executed by one or more processors of the network node, may cause the network node to transmit configuration information indicating cell DRX or DTX cycles for multiple TRPs, the cell DRX or DTX cycles indicating inactive times and active times for the multiple TRPs. The set of instructions, when executed by one or more processors of the network node, may cause the network node to communicate, via one or more TRPs of the multiple TRPs, in accordance with the cell DRX or DTX cycles.

Some aspects described herein relate to an apparatus for wireless communication. The apparatus may include means for receiving configuration information indicating cell DRX or DTX cycles for multiple TRPs, the cell DRX or DTX cycles indicating inactive times and active times for the multiple TRPs. The apparatus may include means for communicating with one or more TRPs, of the multiple TRPs, in accordance with the cell DRX or DTX cycles.

Some aspects described herein relate to an apparatus for wireless communication. The apparatus may include means for transmitting configuration information indicating cell DRX or DTX cycles for multiple TRPs, the cell DRX or DTX cycles indicating inactive times and active times for the multiple TRPs. The apparatus may include means for communicating, via one or more TRPs of the multiple TRPs, in accordance with the cell DRX or DTX cycles.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4A is a diagram illustrating an example of cell discontinuous reception (DRX) and/or discontinuous transmission (DTX), in accordance with the present disclosure.

FIG. 4B is a diagram illustrating an example of cell DRX and/or DTX, in accordance with the present disclosure.

FIG. 5 illustrates an example logical architecture of a distributed radio access network (RAN), in accordance with the present disclosure.

FIG. 6 is a diagram illustrating an example of multi-transmission reception point (TRP) communication, in accordance with the present disclosure.

FIG. 7 is a diagram of an example associated with cell DRX and/or DTX for multiple TRPs, in accordance with the present disclosure.

FIG. 8 is a diagram of an example associated with cell DRX and/or DTX for multiple TRPs, in accordance with the present disclosure.

FIG. 9 is a diagram of an example associated with cell DRX and/or DTX for multiple TRPs, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram illustrating an example of a hardware implementation for an apparatus employing a processing system, in accordance with the present disclosure.

FIG. 14 is a diagram illustrating an example of an implementation of code and circuitry for an apparatus, in accordance with the present disclosure.

FIG. 15 is a diagram of an example apparatus for wireless communication, in accordance with the present disclosure.

FIG. 16 is a diagram illustrating an example of a hardware implementation for an apparatus employing a processing system, in accordance with the present disclosure.

FIG. 17 is a diagram illustrating an example of an implementation of code and circuitry for an apparatus, in accordance with the present disclosure.

### DETAILED DESCRIPTION

Cell discontinuous reception (DRX) and/or cell discontinuous transmission (DTX) enables a network node to conserve power. Cell DRX and/or DTX may be performed according to a cycle that repeats according to a periodicity. The cycle may include an inactive time (e.g., during which the network node may enter a sleep state) and an active time (e.g., during which the network node is awake or in an active state). During the active time, the network node may transmit and/or receive communications with a user equipment (UE) or multiple UEs in a cell served by the network node. “Cell” may refer to a coverage area of the network node. The inactive time may refer to a time duration during which the network node does not perform transmission and/or reception to conserve power. Thus, some physical channels or signals that are scheduled or configured during the inactive time may be dropped by the network node (e.g., in the case of downlink channels or signals) and/or dropped by a UE (e.g., in the case of uplink channels or signals). The term “drop” may be used interchangeably herein with the terms “skip” or “not transmit.” A physical channel or signal may refer to particular radio resources that are used to carry data on an air interface, or a signal that is transmitted over the air interface and conveys information (e.g., amplitude, phase, and/or delay spread) about a communication channel (e.g., a reference signal), respectively.

A transmission reception point (TRP) is an entity of a wireless network that performs transmission and reception of signals. In multi-TRP communication, a UE may communicate with multiple TRPs of the wireless network using different time, frequency, and/or spatial resources to achieve greater diversity, reliability, and/or performance. In general, when cell DRX and/or DTX is used by a wireless network, the same cell DRX and/or DTX cycle may be used for the multiple TRPs. In other words, the multiple TRPs may be active and inactive at the same times, in accordance with the cell DRX and/or DTX cycle. Accordingly, the energy savings that can be achieved by the wireless network are dependent on this single cell DRX and/or DTX cycle. Moreover, when multiple TRPs are using the same cell DRX and/or DTX cycle, a communication of the UE that is scheduled or configured for transmission or reception during an inactive time of the multiple TRPs cannot be communicated until a next active time of the multiple TRPs.

Some techniques and apparatuses described herein enable respective cell DRX and/or DTX cycles to be used for each of the multiple TRPs. By using respective cell DRX and/or DTX cycles for each of the multiple TRPs, active times and inactive times for the TRPs may be coordinated with greater flexibility to achieve improved efficiency and network energy savings. In some aspects, the cell DRX and/or DTX cycles for multiple TRPs may be configured so that when one TRP is inactive, another TRP is active. Accordingly, a communication of the UE that is scheduled or configured for transmission or reception during an inactive time of one TRP can be communicated with another TRP that is in an active time, thereby reducing latency. Techniques and apparatuses described herein may be used to achieve high coverage and/or low latency (e.g., in accordance with a coverage and/or latency requirement) in a scenario in which network load is relatively low (e.g., a low traffic scenario, where multiple TRPs are not needed for distributing load).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

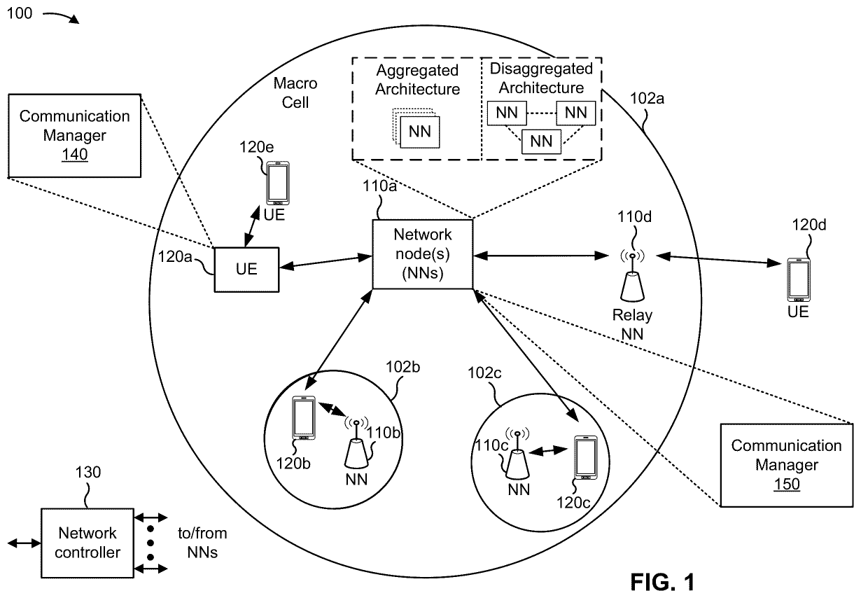

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a TRP, a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information indicating cell DRX or DTX cycles for multiple TRPs, the cell DRX or DTX cycles indicating inactive times and active times for the multiple TRPs; and communicate with one or more TRPs, of the multiple TRPs, in accordance with the cell DRX or DTX cycles. Additionally, or alternatively, the communication manager 140 may perform one or more other operations described herein.

In some aspects, the network node 110 may include a communication manager 150. As described in more detail elsewhere herein, the communication manager 150 may transmit configuration information indicating cell DRX or DTX cycles for multiple TRPs, the cell DRX or DTX cycles indicating inactive times and active times for the multiple TRPs; and communicate, via one or more TRPs of the multiple TRPs, in accordance with the cell DRX or DTX cycles. Additionally, or alternatively, the communication manager 150 may perform one or more other operations described herein.

As indicated above, FIG. 1 is provided as an example. Other examples may differ from what is described with regard to FIG. 1.

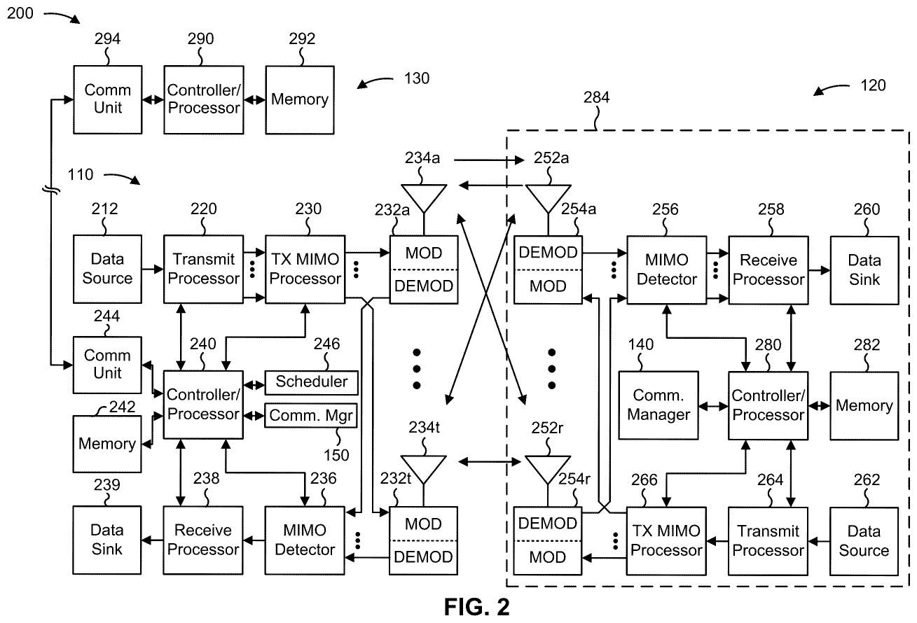

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

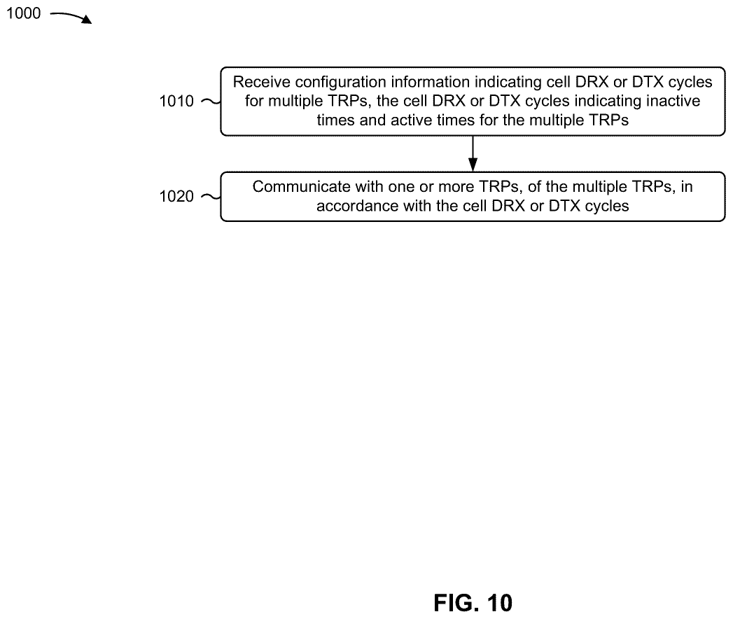

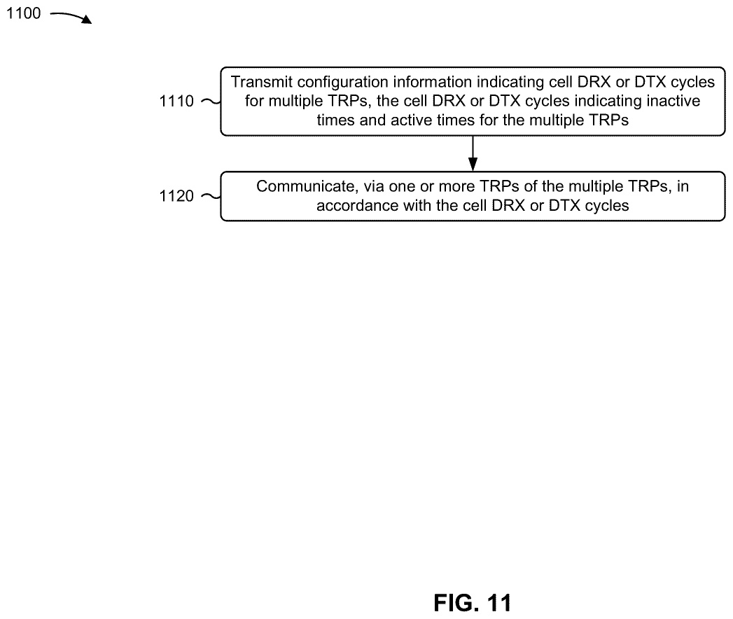

The controller/processor 240 of the network node 110, the controller/processor 280 of the UE 120, and/or any other component(s) of FIG. 2 may perform one or more techniques associated with cell DRX and/or DTX for multiple TRPs, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

In some aspects, the term “receive” and its conjugates (e.g., “receiving” and/or “received,” among other examples) may be alternatively referred to as “obtain” or its respective conjugates (e.g., “obtaining” and/or “obtained,” among other examples). Similarly, the term “transmit” and its conjugates (e.g., “transmitting” and/or “transmitted,” among other examples) may be alternatively referred to as “provide” or its respective conjugates (e.g., “providing” and/or “provided,” among other examples), “generate” or its respective conjugates (e.g., “generating” and/or “generated,” among other examples), and/or “output” or its respective conjugates (e.g., “outputting” and/or “outputted,” among other examples).

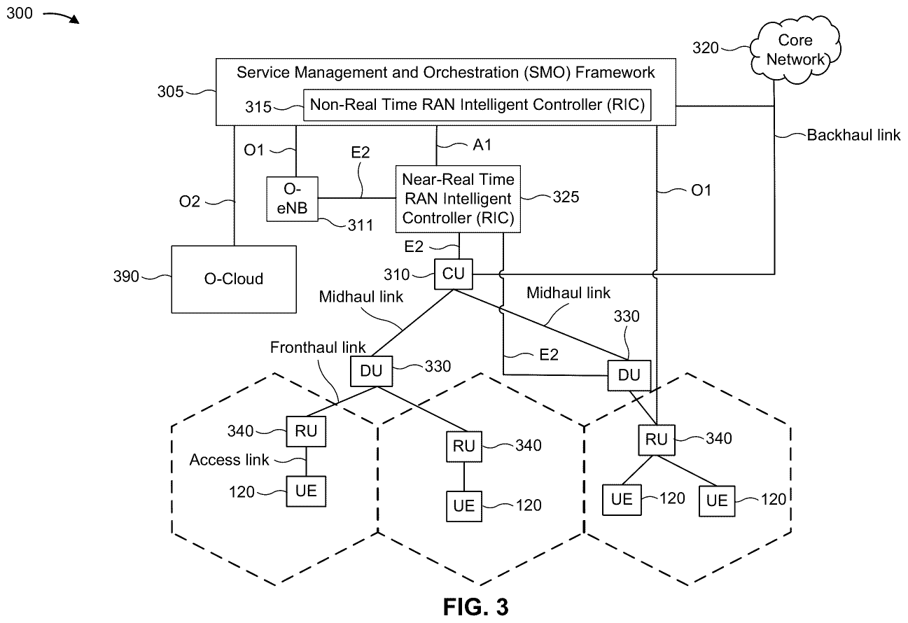

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split.

In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

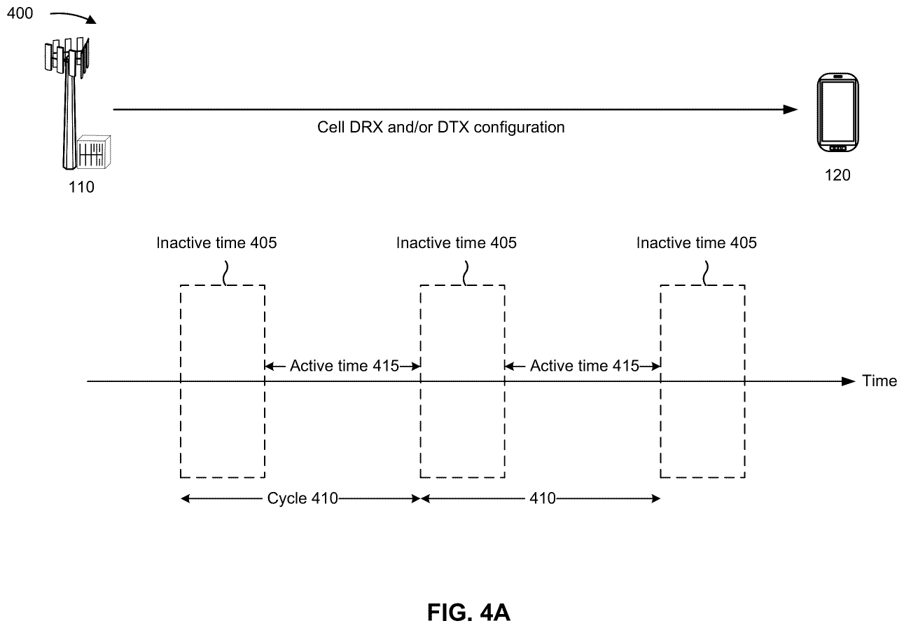

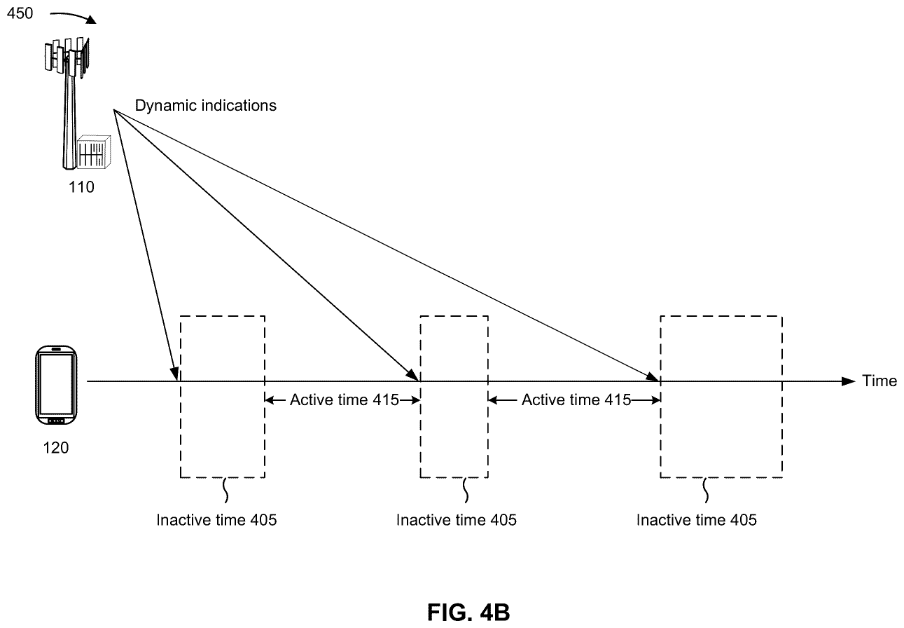

FIG. 4A is a diagram illustrating an example 400 of cell DRX and/or DTX, in accordance with the present disclosure. As shown in FIG. 4A, example 400 includes a UE 120 in communication with a network node 110. In some examples, the UE 120 may be in a connected state (e.g., an RRC connected state) with the network node 110.

As shown, the network node 110 may transmit a cell DRX and/or DTX configuration to the UE 120 to configure a cell DRX and/or DTX cycle 410 for the UE 120 (e.g., semi-statically configured cell DRX and/or DTX). For example, the configuration may be for cell DRX, cell DTX, or both cell DRX and cell DTX. The configuration may indicate an inactive time 405 for the cycle 410. The configuration may indicate a starting time of the inactive time 405 (e.g., a time offset), a duration of the inactive time 405, and/or a periodicity of the inactive time 405, among other examples. One or more types of physical channels or signals may be restricted during the inactive time 405 (e.g., a restricted channel or signal that is scheduled or configured during the inactive time 405 may be dropped by the network node 110 and/or the UE 120). That is, the UE 120 may be expected to not transmit or receive particular channels or signals during the inactive time 405. In this way, the network node 110 may enter a sleep state during the inactive time 405, thereby providing network energy savings. As further shown, cell DRX and/or DTX may include active times 415 outside of (e.g., between) inactive times 405. For example, the configuration may indicate the active time 415 for the cycle 410. As an example, the configuration may indicate a starting time of the active time 415 (e.g., a time offset), a duration of the active time 415, and/or a periodicity of the active time 415, among other examples. Physical channel or signal restrictions applicable to the inactive time 405 may not be applicable to the active time 415. That is, the UE 120 may communicate with the network node 110 during the active time 415. Accordingly, cell DRX and/or DTX may be regarded as a network counterpart of UE DRX.

In cell DRX and/or DTX, the network node 110 has an opportunity to be inactive (e.g., the network node 110 may enter into an inactive state for a period of time). During the inactive times 405, the network node 110 may not need to transmit and/or receive some periodic signals or channels, such as common signals or channels or UE-specific signals or channels. In some examples, during the inactive times 405, the network node 110 and may have no transmission and/or reception. In some other examples, during the inactive times 405, the network node 110 may have only limited transmission and/or reception. In some examples, the network node 110 may inform the UEs 120 in a cell to stop monitoring a physical downlink control channel (PDCCH) and/or to stop measuring channel state information reference signals (CSI-RSs) (e.g., in connection with cell DTX).

In some examples, the cell DRX and/or DTX configuration may be dynamically adapted (e.g., by an indication) by the network node 110. In some examples, cell DRX and/or DTX patterns and/or parameters may be defined for use by a network node 110. In some examples, cell DRX and/or DTX may be coordinated between network nodes using inter-node information exchange. For example, cell DRX and/or DTX patterns may be exchanged across neighboring network nodes 110. In some examples, cell DRX and/or DTX may have no impact on synchronization signal block (SSB) transmissions (e.g., SSB transmissions are not skipped). Moreover, a cell DTX period may be configured so as not to last longer than an SSB period (e.g., 20 ms). In some examples, network energy savings from cell DRX and/or DTX may be enhanced by increasing a number of downlink and/or uplink physical channels or signals that are restricted during inactive time (e.g., in addition to the downlink and/or uplink physical channels or signals that may be restricted using a legacy connected-mode DRX configuration).

In cell DRX and/or DTX, the network node 110 may go into an inactive state with different time granularities. Connected mode DRX (C-DRX) may be configured per UE, and the DTX period for one UE may be an active time for another UE, depending on the scheduler. In this case, the network node 110 may schedule different UEs in different time periods, thereby limiting an amount of time that is left for inactivity at the network node 110. Furthermore, a UE 120 may monitor for particular channels or signals from the network node 110 outside of UE DRX active time, thereby causing a corresponding restriction to the active time of the network node 110. In some examples, cell DRX and/or DTX may be configured in alignment with UE connected-mode DRX (e.g., but affecting idle and/or inactive UEs should be avoided). Moreover, DRX cycles or offsets configured for UEs in connected mode (or idle mode or inactive mode) may be aligned to provide longer inactivity periods at the network node 110 and to reduce activities of the network node 110 (e.g., communicating SSBs, configured grant physical uplink shared channels (PUSCHs), random access channel (RACH) occasions, or the like) outside of UE DRX active time. Alignment of the DRX cycles or offsets for the UEs can be achieved via RRC re-configuration.

As indicated above, FIG. 4A is provided as an example. Other examples may differ from what is described with respect to FIG. 4A.

FIG. 4B is a diagram illustrating an example 450 of cell DRX and/or DTX, in accordance with the present disclosure. As shown in FIG. 4B, example 450 includes a UE 120 in communication with a network node 110. In some examples, the UE 120 may be in a connected state (e.g., an RRC connected state) with the network node 110.

As shown, an inactive time 405 for cell DRX and/or DTX (e.g., a cell DRX and/or DTX inactive state) may be dynamically triggered (e.g., dynamically configured cell DRX and/or DTX). The inactive time 405 may be for cell DRX, cell DTX, or both cell DRX and cell DTX. As an example, the network node 110 may transmit downlink control information (DCI) to the UE 120 that indicates an inactive time 405 for cell DRX and/or DTX (e.g., a starting time of the inactive time 405 and/or a duration of the inactive time 405). In other words, each inactive time 405 may be triggered by respective dynamic indications from the network node 110. Accordingly, each inactive time 405 may have a respective duration and may occur non-cyclically in accordance with the dynamic indications. Active times 415 may be between the inactive times 405.

As indicated above, FIG. 4B is provided as an example. Other examples may differ from what is described with respect to FIG. 4B.

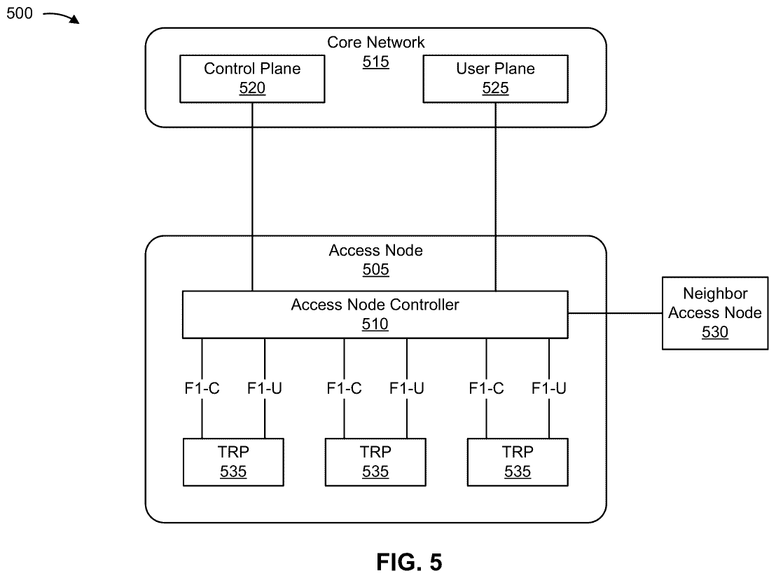

FIG. 5 illustrates an example logical architecture of a distributed RAN 500, in accordance with the present disclosure.

An access node 505 may include an access node controller 510. The access node controller 510 may be a CU of the distributed RAN 500. In some aspects, a backhaul interface to a core network 515 (e.g., a 5G core network) may terminate at the access node controller 510. The core network 515 may include a control plane component 520 and a user plane component 525 (e.g., a 5G gateway), and the backhaul interface for one or both of the control plane and the user plane may terminate at the access node controller 510. Additionally, or alternatively, a backhaul interface to one or more neighbor access nodes 530 (e.g., another 5G access node 505 and/or an LTE access node) may terminate at the access node controller 510.

The access node controller 510 may include and/or may communicate with one or more TRPs 535 (e.g., via an F1 Control (F1-C) interface and/or an F1 User (F1-U) interface). A TRP 535 may include a DU and/or an RU of the distributed RAN 500. In some aspects, a TRP 535 may correspond to a network node 110 described above in connection with FIG. 1. For example, different TRPs 535 may be included in different network nodes 110. Additionally, or alternatively, multiple TRPs 535 may be included in a single network node 110. In some aspects, a network node 110 may include a CU (e.g., access node controller 510) and/or one or more DUs (e.g., one or more TRPs 535). In some cases, a TRP 535 may be referred to as a cell, a panel, an antenna array, or an array.

A TRP 535 may be connected to a single access node controller 510 or to multiple access node controllers 510. In some aspects, a dynamic configuration of split logical functions may be present within the architecture of distributed RAN 500, referred to elsewhere herein as a functional split. For example, a PDCP layer, an RLC layer, and/or a MAC layer may be configured to terminate at the access node controller 510 or at a TRP 535.

In some aspects, multiple TRPs 535 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 535 may be configured to individually (e.g., using dynamic selection) or jointly (e.g., using joint transmission with one or more other TRPs 535) serve traffic to a UE 120.

As indicated above, FIG. 5 is provided as an example. Other examples may differ from what was described with regard to FIG. 5.

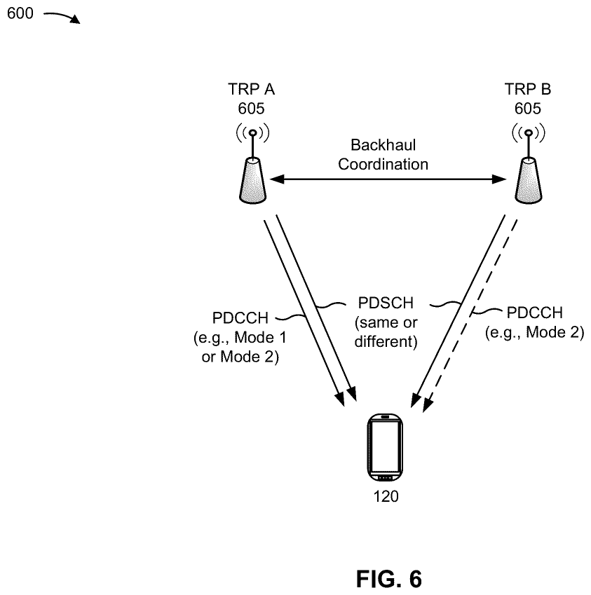

FIG. 6 is a diagram illustrating an example 600 of multi-TRP communication (sometimes referred to as multi-panel communication), in accordance with the present disclosure. As shown in FIG. 6, multiple TRPs 605 may communicate with the same UE 120. A TRP 605 may correspond to a TRP 535 described above in connection with FIG. 5.

The multiple TRPs 605 (shown as TRP A and TRP B) may communicate with the same UE 120 in a coordinated manner (e.g., using coordinated multipoint transmissions) to improve reliability and/or increase throughput. The TRPs 605 may coordinate such communications via an interface between the TRPs 605 (e.g., a backhaul interface and/or an access node controller 510). The interface may have a smaller delay and/or higher capacity when the TRPs 605 are co-located at the same network node 110 (e.g., when the TRPs 605 are different antenna arrays or panels of the same network node 110), and may have a larger delay and/or lower capacity (as compared to co-location) when the TRPs 605 are located at different network nodes 110. The different TRPs 605 may communicate with the UE 120 using different QCL relationships (e.g., different TCI states), different DMRS ports, and/or different layers (e.g., of a multi-layer communication).

In a first multi-TRP transmission mode (e.g., Mode 1), a single PDCCH may be used to schedule downlink data communications for a single physical downlink shared channel (PDSCH). In this case, multiple TRPs 605 (e.g., TRP A and TRP B) may transmit communications to the UE 120 on the same PDSCH. For example, a communication may be transmitted using a single codeword with different spatial layers for different TRPs 605 (e.g., where one codeword maps to a first set of layers transmitted by a first TRP 605 and maps to a second set of layers transmitted by a second TRP 605). As another example, a communication may be transmitted using multiple codewords, where different codewords are transmitted by different TRPs 605 (e.g., using different sets of layers). In either case, different TRPs 605 may use different QCL relationships (e.g., different TCI states) for different DMRS ports corresponding to different layers. For example, a first TRP 605 may use a first QCL relationship or a first TCI state for a first set of DMRS ports corresponding to a first set of layers, and a second TRP 605 may use a second (different) QCL relationship or a second (different) TCI state for a second (different) set of DMRS ports corresponding to a second (different) set of layers. In some aspects, a TCI state in DCI (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 605, and a second PDCCH may schedule a second codeword to be transmitted by a second TRP 605. Furthermore, first DCI (e.g., transmitted by the first TRP 605) may schedule a first PDSCH communication associated with a first set of DMRS ports with a first QCL relationship (e.g., indicated by a first TCI state) for the first TRP 605, and second DCI (e.g., transmitted by the second TRP 605) may schedule a second PDSCH communication associated with a second set of DMRS ports with a second QCL relationship (e.g., indicated by a second TCI state) for the second TRP 605. In this case, DCI (e.g., having DCI format 1_0 or DCI format 1_1) may indicate a corresponding TCI state for a TRP 605 corresponding to the DCI. The TCI field of a DCI indicates the corresponding TCI state (e.g., the TCI field of the first DCI indicates the first TCI state and the TCI field of the second DCI indicates the second TCI state).

In a multi-TRP communication scenario, diversity, reliability, and/or performance may be improved by enabling a UE to communicate with multiple TRPs using different frequency resources, different time resources, and/or different spatial resources. In general, when cell DRX and/or DTX is used by a wireless network, the same cell DRX and/or DTX cycle may be used for the multiple TRPs. In other words, the multiple TRPs may be active and inactive at the same times in accordance with the cell DRX and/or DTX cycle. Accordingly, an amount of network energy savings that can be achieved is based on this single cell DRX and/or DTX cycle. Moreover, when multiple TRPs are using the same cell DRX and/or DTX cycle, a communication of the UE that is scheduled or configured for transmission or reception during an inactive time of the multiple TRPs cannot be communicated until a next active time of the multiple TRPs.

Some techniques and apparatuses described herein enable respective cell DRX and/or DTX cycles to be used for each of the multiple TRPs. By using respective cell DRX and/or DTX cycles for each of the multiple TRPs, active times and inactive times for the TRPs may be coordinated with greater flexibility to achieve improved efficiency and network energy savings. In some aspects, the cell DRX and/or DTX cycles for multiple TRPs may be configured so that when one TRP is inactive, another TRP is active. Accordingly, a communication of the UE that is scheduled or configured for transmission or reception during an inactive time of one TRP can be communicated with another TRP that is in an active time, thereby reducing latency. Techniques and apparatuses described herein may be used to achieve high coverage and/or low latency (e.g., in accordance with a coverage and/or latency requirement) in a scenario in which network load is relatively low (e.g., a low traffic scenario, where multiple TRPs are not needed for distributing load).

As indicated above, FIG. 6 is provided as an example. Other examples may differ from what is described with respect to FIG. 6.

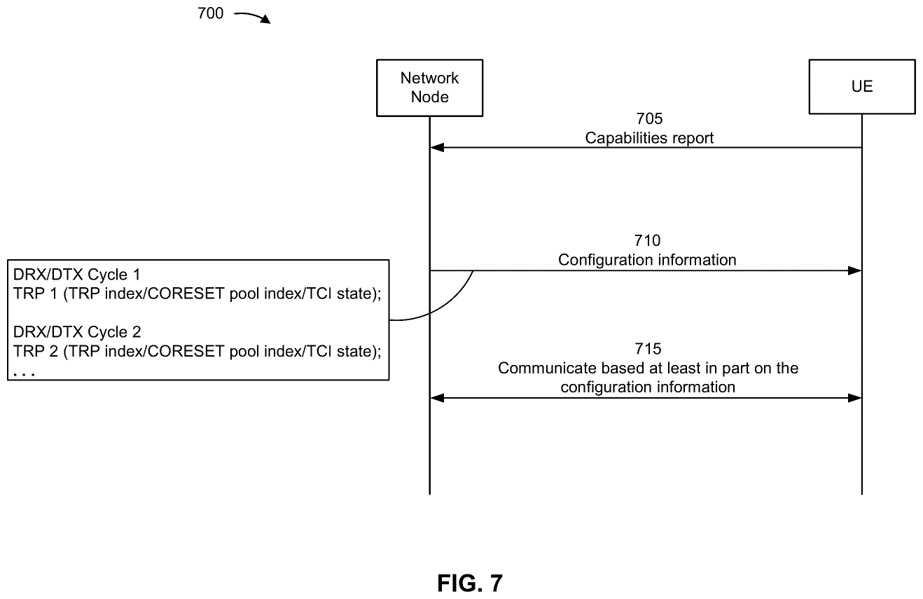

FIG. 7 is a diagram of an example 700 associated with cell DRX and/or DTX for multiple TRPs, in accordance with the present disclosure. As shown in FIG. 7, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 7.

As shown by reference number 705, the UE may transmit, and the network node may receive, a capabilities report. In some aspects, the capabilities report may indicate UE support for using per-TRP cell DRX and/or DTX cycle definitions. As shown by reference number 710, the network node may transmit, and the UE may receive, configuration information. In some aspects, the UE may receive the configuration information via one or more of RRC signaling, one or more MAC control elements (MAC-CEs), and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate cell DRX and/or DTX cycles for multiple TRPs (e.g., multiple TRPs used for multi-TRP communication for the UE). For example, a cell DRX and/or DTX cycle may be defined per (i.e., for each) TRP. The cell DRX and/or DTX cycles may indicate inactive times and active times for each of the multiple TRPs. For example, a first cell DRX and/or DTX cycle may indicate an inactive time and an active time for a first TRP, and a second cell DRX and/or DTX cycle may indicate an inactive time and an active time for a second TRP. In some aspects, according to the cell DRX and/or DTX cycles, a first inactive time for a first TRP may be non-aligned in time with a second inactive time for a second TRP (e.g., the first inactive time and the second inactive time may not overlap in time or may only partially overlap in time). For example, in a cell DRX and/or DTX cycle, one TRP may be active while one or more other TRPs may be inactive.

The configuration information may indicate associations between the cell DRX and/or DTX cycles and the multiple TRPs. In some aspects, the configuration information may indicate associations between the cell DRX and/or DTX cycles and the multiple TRPs using TRP indices (e.g., a cell DRX and/or DTX cycle may be connected to a TRP through a TRP index). A TRP index may include an identifier for a particular TRP.

In some aspects, the configuration information may indicate associations between the cell DRX and/or DTX cycles and the multiple TRPs using control resource set (CORESET) pool indices (e.g., a cell DRX and/or DTX cycle may be connected to a TRP through a CORESET pool index). “CORESET” may refer to a control region that is structured to support an efficient use of resources. A CORESET may occupy the first symbol, the first two symbols, or the first three symbols of an orthogonal frequency division multiplexing (OFDM) slot. Thus, a CORESET may include multiple resource blocks (RBs) in the frequency domain, and either one, two, or three symbols in the time domain. The UE may be configured with multiple CORESETs in a given serving cell, and each CORESET may be associated with a CORESET identifier (CORESET ID). Two or more (e.g., up to five) CORESETs may be grouped into a CORESET pool, and each CORESET pool may be associated with a CORESET pool index. In a multi-TRP configuration, each CORESET pool index value may be associated with a particular TRP. The UE may be configured with a higher layer parameter (e.g., in a PDCCH-Config) with information identifying an association between a TRP and a CORESET pool index value assigned to the TRP.

In some aspects, the configuration information may indicate associations between the cell DRX and/or DTX cycles and the multiple TRPs using TCI states (e.g., a cell DRX and/or DTX cycle may be connected to a TRP through a TCI state). A TCI state may indicate a directionality or a characteristic of a downlink beam, such as one or more QCL properties of the downlink beam. A QCL property may include, for example, a Doppler shift, a Doppler spread, an average delay, a delay spread, or spatial receive parameters, among other examples. The UE may be configured with information identifying an association between a TRP and a TCI state.

In this way, the UE may be configured with multiple cell DRX and/or DTX cycles, where each cycle is indexed by a TRP index, a CORESET pool index, and/or a set of TCI states. In some aspects, the configuration may indicate a single DRX and/or DTX cycle that is for one TRP, and a DRX and/or DTX cycle for another TRP may be an inverse of the single DRX and/or DTX cycle (e.g., the DRX and/or DTX cycle for the other TRP may be implicitly indicated by the single DRX and/or DTX cycle). For example, the UE may be configured with a cell DRX and/or DTX cycle such that when the DRX and/or DTX cycle is active in one TRP, it is automatically inactive in another TRP (and vice versa). Inverse DRX and/or DTX cycles may refer to multiple DRX and/or DTX cycles where an active time of one cycle corresponds in time to an inactive time of another cycle.

The UE may configure itself based at least in part on the configuration information. In some aspects, the UE may be configured to perform one or more operations described herein based at least in part on the configuration information.

As shown by reference number 715, the UE and the network node may communicate based at least in part on the configuration information. For example, the UE may communicate with one or more TRPs, of the multiple TRPs, in accordance with the cell DRX and/or DTX cycles. Similarly, the network node may communicate via one or more TRPs, of the multiple TRPs, in accordance with the cell DRX and/or DTX cycles.

In some aspects, to communicate, the UE and/or the network node may drop a communication, associated with a TRP (e.g., intended for transmission or reception by the TRP), during an inactive time for the TRP (e.g., according to a cell DRX and/or DTX cycle associated with the TRP). For example, if a TRP is in inactive time, the activities of the TRP can be dropped. In some aspects, to communicate, the UE and/or the network node may transfer a communication, associated with a TRP, during an inactive time for the TRP (e.g., according to a cell DRX and/or DTX cycle associated with the TRP) to another TRP that is in an active time (e.g., according to a cell DRX and/or DTX cycle associated with the other TRP). For example, if a TRP is in inactive time, the activities of the TRP can be transferred to an active TRP. In some aspects, to communicate, the UE and/or the network node may drop or transfer a communication, associated with a TRP, during an inactive time for the TRP (e.g., according to a cell DRX and/or DTX cycle associated with the TRP) based on a type of physical channel or signal associated with the communication. For example, if a TRP is in inactive time, the behavior for activities of the TRP may depend on a type of channel or signal. For example, a first type of channel or signal may be dropped, and a second type of channel or signal may be transferred.

“Dropping” a communication may refer to the UE and/or the network node skipping or otherwise not transmitting or receiving a communication in a time occasion in which the communication was scheduled or configured. “Transferring” a communication may refer to the UE transmitting the communication to, or receiving the communication from, a TRP other than the TRP for which the communication was scheduled or configured, and/or may refer to the network node transmitting or receiving the communication via a TRP other than the TRP for which the communication was scheduled or configured.

In some aspects, to communicate, the UE and/or the network node may drop an uplink communication, associated with a TRP, during an inactive time for the TRP (e.g., during a cell DRX inactive duration of the TRP). For example, the UE may drop an uplink transmission to the inactive TRP. Alternatively, the UE may transmit an uplink communication associated with a TRP, during an inactive time of the TRP (e.g., during a cell DRX inactive duration of the TRP), to another TRP that is in an active time, and the network node may receive the uplink communication via the other TRP. The UE may transmit the uplink communication to the active TRP according to a configuration associated with the active TRP. For example, the UE may transmit the uplink communication using a TCI state, an MCS, and/or a transmit power, among other examples, that is to be used for the active TRP (e.g., rather than using a TCI state, an MCS, and/or a transmit power associated with the inactive TRP in accordance with scheduling or a configuration for the communication). An uplink communication may be a physical uplink control channel (PUCCH) communication or a PUSCH communication.

In some aspects, to communicate, the UE and/or the network node may drop a sounding reference signal (SRS) communication, associated with a TRP, during an inactive time of the TRP (e.g., during a cell DRX inactive duration of the TRP). For example, the UE may drop a transmission of an SRS to an inactive TRP. Alternatively, the UE may transmit an SRS, associated with a TRP, to the TRP during an inactive time of the TRP (e.g., during a cell DRX inactive duration of the TRP), and the network node may receive the SRS communication via the TRP (e.g., the UE may still transmit an SRS to the TRP in an inactive duration).

Based at least in part on using cell DRX and/or DTX cycles that are defined per TRP. TRP inactive times may be efficiently coordinated, thereby improving network energy savings. Furthermore, based at least in part on using cell DRX and/or DTX cycles that are defined per TRP, network energy savings can be achieved while reducing latency.

As indicated above, FIG. 7 is provided as an example. Other examples may differ from what is described with respect to FIG. 7.

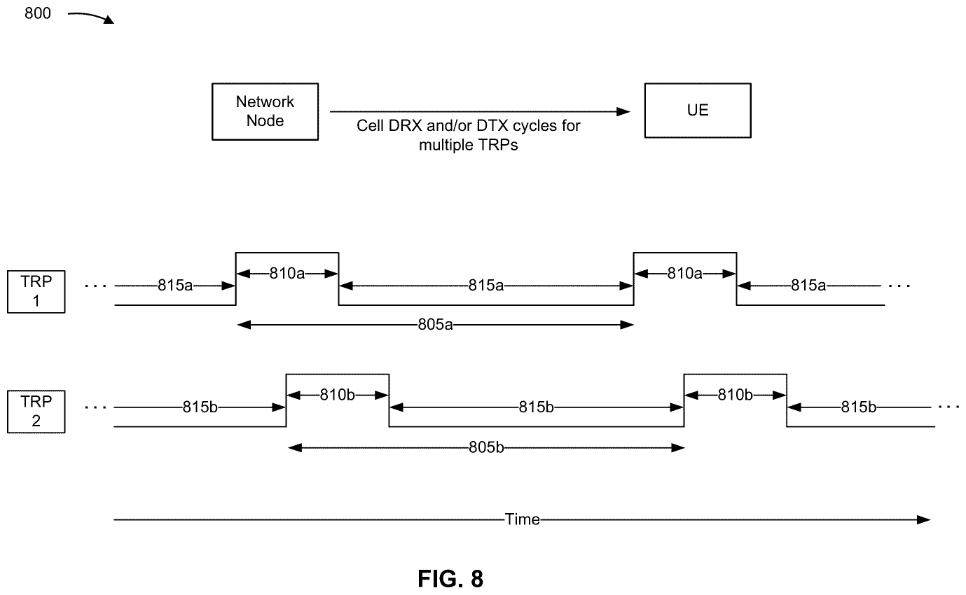

FIG. 8 is a diagram of an example 800 associated with cell DRX and/or DTX for multiple TRPs, in accordance with the present disclosure. Example 800 includes the UE and the network node described in connection with FIG. 7.

As shown, the network node may transmit, and the UE may receive, configuration information indicating multiple cell DRX and/or DTX cycles for multiple TRPs (e.g., each cell DRX and/or DTX cycle is for a respective TRP). The multiple cell DRX and/or DTX cycles may include a first cell DRX and/or DTX cycle 805a associated with a first TRP (TRP 1) and a second cell DRX and/or DTX cycle 805b associated with a second TRP (TRP 2). As shown, active times 810a and inactive times 815a of the first cell DRX and/or DTX cycle 805a may be non-aligned in time with active times 810b and inactive times 815b of the second cell DRX and/or DTX cycle. Accordingly, the first TRP may be active while the second TRP is inactive, or the first TRP may be inactive while the second TRP is active. Thus, if one of the TRPs goes into inactive time, the activities of that TRP can be dropped or transferred to the active TRP, as described herein.

As indicated above, FIG. 8 is provided as an example. Other examples may differ from what is described with respect to FIG. 8.

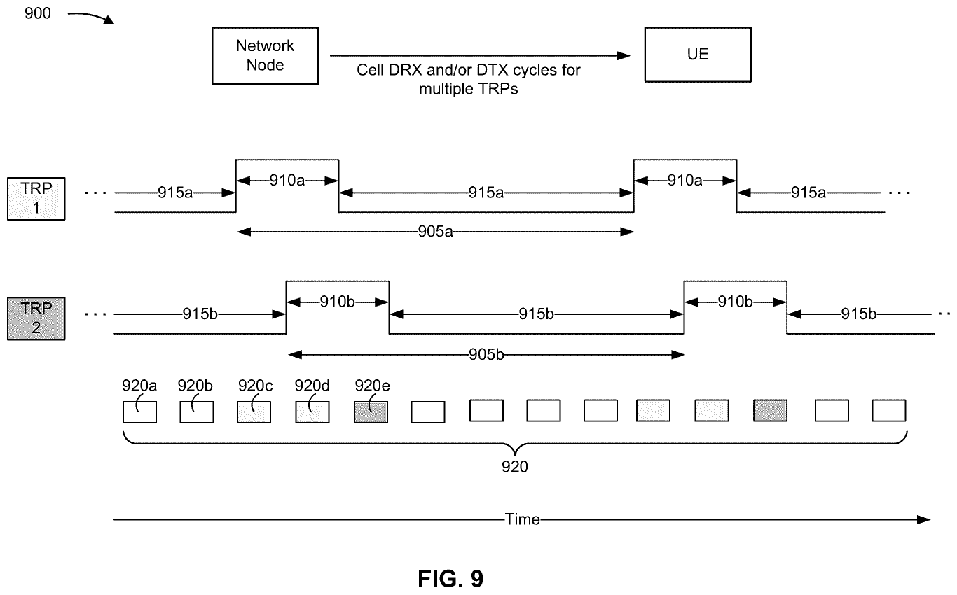

FIG. 9 is a diagram of an example 900 associated with cell DRX and/or DTX for multiple TRPs, in accordance with the present disclosure. Example 900 includes the UE and the network node described in connection with FIG. 7.

As shown, the network node may transmit, and the UE may receive, configuration information indicating multiple cell DRX and/or DTX cycles for multiple TRPs (e.g., each cell DRX and/or DTX cycle is for a respective TRP). The multiple cell DRX and/or DTX cycles may include a first cell DRX and/or DTX cycle 905a associated with a first TRP (TRP 1) and a second cell DRX and/or DTX cycle 905b associated with a second TRP (TRP 2). As shown, active times 910a and inactive times 915a of the first cell DRX and/or DTX cycle 905a may be non-aligned in time with active times 910b and inactive times 915b of the second cell DRX and/or DTX cycle. Accordingly, the first TRP may be active while the second TRP is inactive, or the first TRP may be inactive while the second TRP is active.

In addition, the UE may be configured with a plurality of transmission occasions 920 (e.g., that occur periodically) for performing transmissions (e.g., a PUCCH transmission, a PUSCH transmission, an SRS transmission, or the like) to the first TRP. For example, the transmission occasions 920 may be associated with a configured grant for the UE. As shown, the UE may drop transmissions in transmission occasions 920a, 920b that are during an inactive time 915a of the first TRP and an inactive time 915b of the second TRP (e.g., when both the first TRP and the second TRP are inactive). During an active time 910a of the first TRP, the UE may perform transmissions to the first TRP in transmission occasions 920c, 920d (e.g., regardless of whether the second TRP is active or inactive). During an inactive time 915a of the first TRP, and during an active time 910b of the second TRP (e.g., the first TRP is inactive but the second TRP is active), the UE may perform a transmission to the second TRP in transmission occasion 920e.

As indicated above, FIG. 9 is provided as an example. Other examples may differ from what is described with respect to FIG. 9.

FIG. 10 is a diagram illustrating an example process 1000 performed, for example, by a UE, in accordance with the present disclosure. Example process 1000 is an example where the UE (e.g., UE 120) performs operations associated with cell DRX or DTX for multiple TRPs.

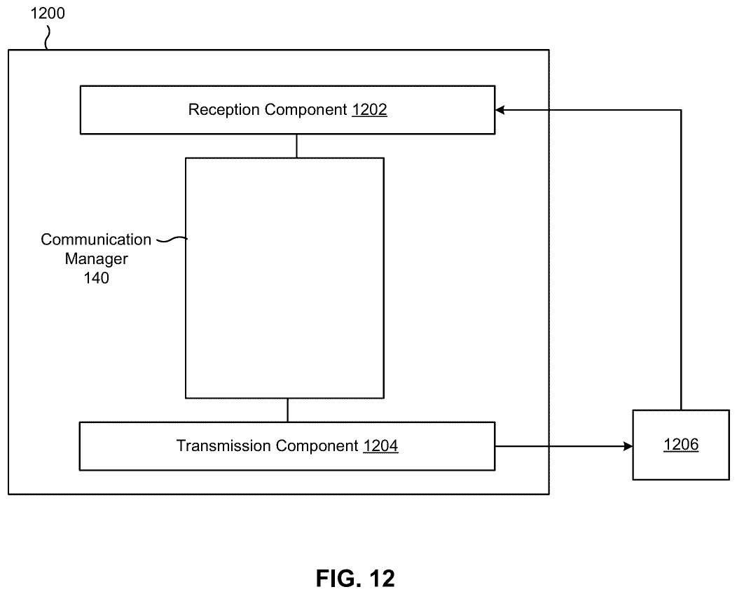

As shown in FIG. 10, in some aspects, process 1000 may include receiving configuration information indicating cell DRX or DTX cycles for multiple TRPs, the cell DRX or DTX cycles indicating inactive times and active times for the multiple TRPs (block 1010). For example, the UE (e.g., using communication manager 140 and/or reception component 1202, depicted in FIG. 12) may receive configuration information indicating cell DRX or DTX cycles for multiple TRPs, the cell DRX or DTX cycles indicating inactive times and active times for the multiple TRPs, as described above.

As further shown in FIG. 10, in some aspects, process 1000 may include communicating with one or more TRPs, of the multiple TRPs, in accordance with the cell DRX or DTX cycles (block 1020). For example, the UE (e.g., using communication manager 140, reception component 1202, and/or transmission component 1204, depicted in FIG. 12) may communicate with one or more TRPs, of the multiple TRPs, in accordance with the cell DRX or DTX cycles, as described above.

Process 1000 may include additional aspects, such as any single aspect or any combination of aspects described below and/or in connection with one or more other processes described elsewhere herein.

In a first aspect, a first inactive time for a first TRP, of the multiple TRPs, is non-aligned in time with a second inactive time for a second TRP of the multiple TRPs.

In a second aspect, alone or in combination with the first aspect, communicating with the one or more TRPs includes dropping a communication associated with a TRP, of the multiple TRPs, during an inactive time for the TRP.

In a third aspect, alone or in combination with one or more of the first and second aspects, communicating with the one or more TRPs includes transferring a communication associated with a TRP, of the multiple TRPs, during an inactive time for the TRP, to another TRP, of the multiple TRPs, that is in an active time.

In a fourth aspect, alone or in combination with one or more of the first through third aspects, communicating with the one or more TRPs includes dropping or transferring a communication associated with a TRP, of the multiple TRPs, during an inactive time for the TRP, based on a type of physical channel or signal associated with the communication.

In a fifth aspect, alone or in combination with one or more of the first through fourth aspects, the configuration information indicates associations between the cell DRX or DTX cycles and the multiple TRPs using TRP indices.

In a sixth aspect, alone or in combination with one or more of the first through fifth aspects, the configuration information indicates associations between the cell DRX or DTX cycles and the multiple TRPs using control resource set pool indices.

In a seventh aspect, alone or in combination with one or more of the first through sixth aspects, the configuration information indicates associations between the cell DRX or DTX cycles and the multiple TRPs using transmission configuration indicator states.

In an eighth aspect, alone or in combination with one or more of the first through seventh aspects, the configuration information indicates a single DRX or DTX cycle that is for a TRP, of the multiple TRPs, and a DRX or DTX cycle for another TRP, of the multiple TRPs, is an inverse of the single DRX or DTX cycle.

In a ninth aspect, alone or in combination with one or more of the first through eighth aspects, communicating with the one or more TRPs includes dropping an uplink communication associated with a TRP, of the multiple TRPs, during an inactive time for the TRP.

In a tenth aspect, alone or in combination with one or more of the first through ninth aspects, communicating with the one or more TRPs includes transmitting an uplink communication associated with a TRP, of the multiple TRPs, during an inactive time of the TRP, to another TRP, of the multiple TRPs, that is in an active time.

In an eleventh aspect, alone or in combination with one or more of the first through tenth aspects, communicating with the one or more TRPs includes dropping a sounding reference signal communication associated with a TRP, of the multiple TRPs, during an inactive time of the TRP.

In a twelfth aspect, alone or in combination with one or more of the first through eleventh aspects, communicating with the one or more TRPs includes transmitting a sounding reference signal communication associated with a TRP, of the multiple TRPs, to the TRP, during an inactive time of the TRP.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with cell DRX or DTX for multiple TRPs.

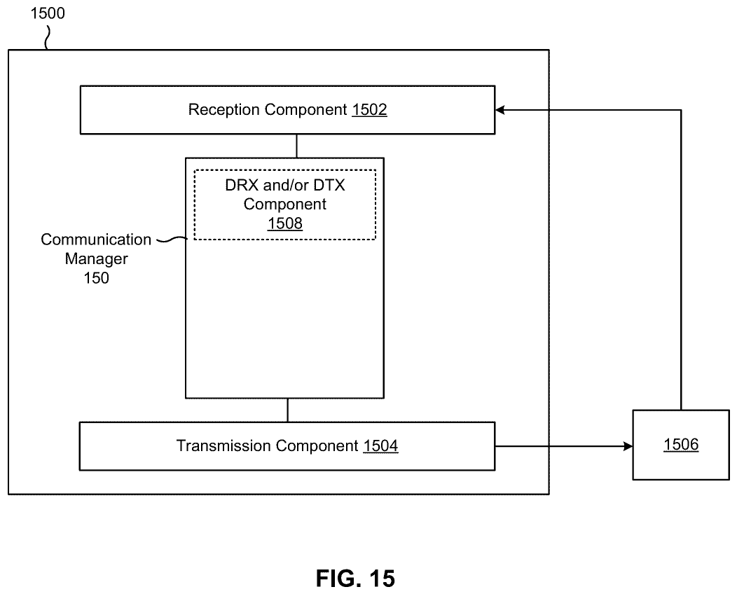

As shown in FIG. 11, in some aspects, process 1100 may include transmitting configuration information indicating cell DRX or DTX cycles for multiple TRPs, the cell DRX or DTX cycles indicating inactive times and active times for the multiple TRPs (block 1110). For example, the network node (e.g., using communication manager 150 and/or transmission component 1504, depicted in FIG. 15) may transmit configuration information indicating cell DRX or DTX cycles for multiple TRPs, the cell DRX or DTX cycles indicating inactive times and active times for the multiple TRPs, as described above.

As further shown in FIG. 11, in some aspects, process 1100 may include communicating, via one or more TRPs of the multiple TRPs, in accordance with the cell DRX or DTX cycles (block 1120). For example, the network node (e.g., using communication manager 150, reception component 1502, and/or transmission component 1504, depicted in FIG. 15) may communicate, via one or more TRPs of the multiple TRPs, in accordance with the cell DRX or DTX cycles, as described above.

Process 1100 may include additional aspects, such as any single aspect or any combination of aspects described below and/or in connection with one or more other processes described elsewhere herein.

In a first aspect, a first inactive time for a first TRP, of the multiple TRPs, is non-aligned in time with a second inactive time for a second TRP of the multiple TRPs.

In a second aspect, alone or in combination with the first aspect, communicating via the one or more TRPs includes dropping a communication associated with a TRP, of the multiple TRPs, during an inactive time for the TRP.

In a third aspect, alone or in combination with one or more of the first and second aspects, communicating via the one or more TRPs includes transferring a communication associated with a TRP, of the multiple TRPs, during an inactive time for the TRP, to another TRP, of the multiple TRPs, that is in an active time.

In a fourth aspect, alone or in combination with one or more of the first through third aspects, communicating via the one or more TRPs includes dropping or transferring a communication associated with a TRP, of the multiple TRPs, during an inactive time for the TRP, based on a type of physical channel or signal associated with the communication.

In a fifth aspect, alone or in combination with one or more of the first through fourth aspects, the configuration information indicates associations between the cell DRX or DTX cycles and the multiple TRPs using TRP indices.

In a sixth aspect, alone or in combination with one or more of the first through fifth aspects, the configuration information indicates associations between the cell DRX or DTX cycles and the multiple TRPs using control resource set pool indices.

In a seventh aspect, alone or in combination with one or more of the first through sixth aspects, the configuration information indicates associations between the cell DRX or DTX cycles and the multiple TRPs using transmission configuration indicator states.

In an eighth aspect, alone or in combination with one or more of the first through seventh aspects, the configuration information indicates a single DRX or DTX cycle that is for a TRP, of the multiple TRPs, and a DRX or DTX cycle for another TRP, of the multiple TRPs, is an inverse of the single DRX or DTX cycle.

In a ninth aspect, alone or in combination with one or more of the first through eighth aspects, communicating via the one or more TRPs includes dropping an uplink communication associated with a TRP, of the multiple TRPs, during an inactive time for the TRP.

In a tenth aspect, alone or in combination with one or more of the first through ninth aspects, communicating via the one or more TRPs includes receiving an uplink communication associated with a TRP, of the multiple TRPs, during an inactive time of the TRP via another TRP, of the multiple TRPs, that is in an active time.

In an eleventh aspect, alone or in combination with one or more of the first through tenth aspects, communicating via the one or more TRPs includes dropping a sounding reference signal communication associated with a TRP, of the multiple TRPs, during an inactive time of the TRP.

In a twelfth aspect, alone or in combination with one or more of the first through eleventh aspects, communicating via the one or more TRPs includes receiving a sounding reference signal communication associated with a TRP, of the multiple TRPs, via the TRP, during an inactive time of the TRP.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140.

In some aspects, the apparatus 1200 may be configured to perform one or more operations described herein in connection with FIGS. 7-9. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive configuration information indicating cell DRX or DTX cycles for multiple TRPs. The cell DRX or DTX cycles may indicate inactive times and active times for the multiple TRPs. The reception component 1202 and/or the transmission component 1204 may communicate with one or more TRPs, of the multiple TRPs. in accordance with the cell DRX or DTX cycles.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

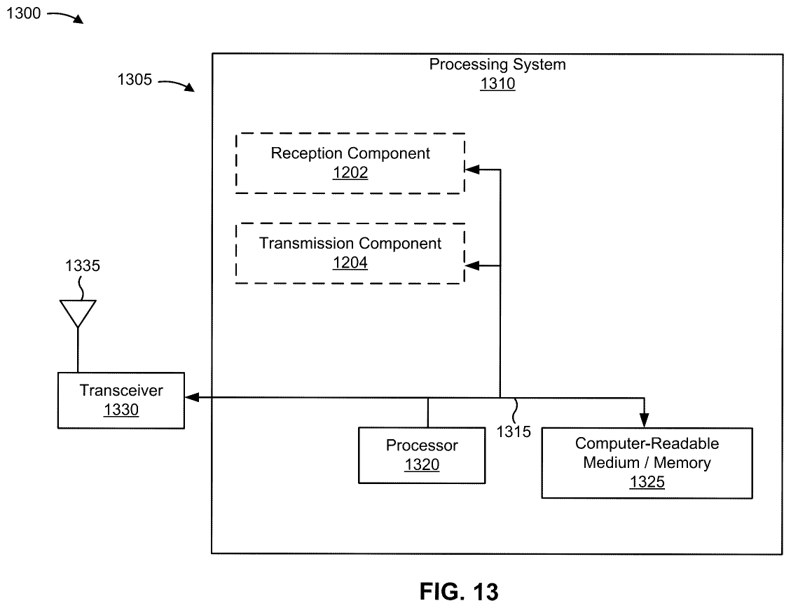

FIG. 13 is a diagram illustrating an example 1300 of a hardware implementation for an apparatus 1305 employing a processing system 1310, in accordance with the present disclosure. The apparatus 1305 may be a UE.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the processor 1320, the illustrated components, and the computer-readable medium/memory 1325. The bus 1315 may also link various other circuits, such as timing sources, peripherals, voltage regulators, and/or power management circuits.

The processing system 1310 may be coupled to a transceiver 1330. The transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes a processor 1320 coupled to a computer-readable medium/memory 1325. The processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the UE 120 and may include the memory 282 and/or at least one of the TX MIMO processor 266, the receive processor 258, and/or the controller/processor 280. In some aspects, the apparatus 1305 for wireless communication includes means for receiving configuration information indicating cell DRX or DTX cycles for multiple TRPs, the cell DRX or DTX cycles indicating inactive times and active times for the multiple TRPs; and/or means for communicating with one or more TRPs, of the multiple TRPs, in accordance with the cell DRX or DTX cycles. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 266, the receive processor 258, and/or the controller/processor 280. In one configuration, the aforementioned means may be the TX MIMO processor 266, the receive processor 258, and/or the controller/processor 280 configured to perform the functions and/or operations recited herein.

FIG. 13 is provided as an example. Other examples may differ from what is described in connection with FIG. 13.

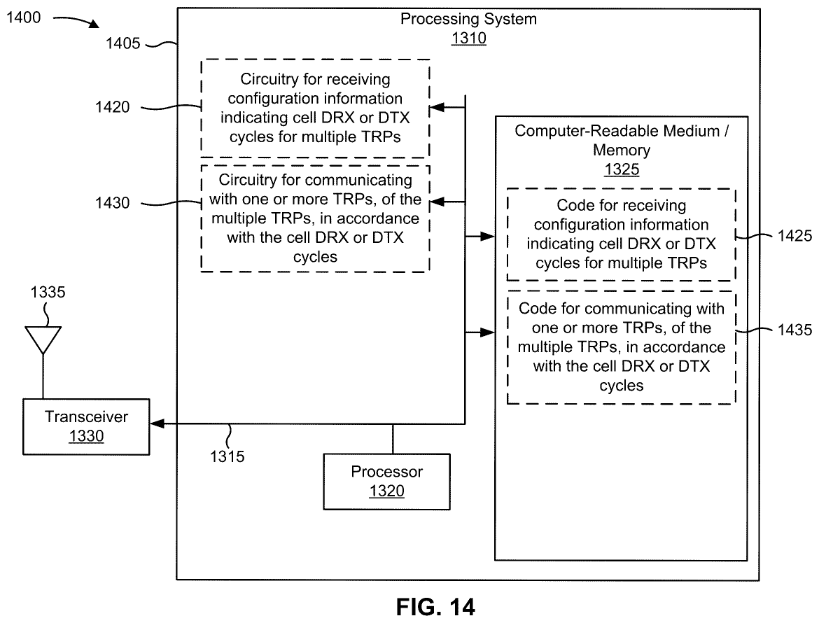

FIG. 14 is a diagram illustrating an example 1400 of an implementation of code and circuitry for an apparatus 1405, in accordance with the present disclosure. The apparatus 1405 may be a UE, or a UE may include the apparatus 1405.

As shown in FIG. 14, the apparatus 1405 may include circuitry for receiving configuration information indicating cell DRX or DTX cycles for multiple TRPs (circuitry 1420). For example, the circuitry 1420 may enable the apparatus 1405 to receive configuration information indicating cell DRX or DTX cycles for multiple TRPs. The cell DRX or DTX cycles may indicate inactive times and active times for the multiple TRPs.

As shown in FIG. 14, the apparatus 1405 may include, stored in computer-readable medium 1325, code for receiving configuration information indicating cell DRX or DTX cycles for multiple TRPs (code 1425). For example, the code 1425, when executed by processor 1320, may cause processor 1320 to cause transceiver 1330 to receive configuration information indicating cell DRX or DTX cycles for multiple TRPs.

As shown in FIG. 14, the apparatus 1405 may include circuitry for communicating with one or more TRPs, of the multiple TRPs, in accordance with the cell DRX or DTX cycles (circuitry 1430). For example, the circuitry 1430 may enable the apparatus 1405 to communicate with one or more TRPs, of the multiple TRPs, in accordance with the cell DRX or DTX cycles.

As shown in FIG. 14, the apparatus 1405 may include, stored in computer-readable medium 1325, code for communicating with one or more TRPs, of the multiple TRPs, in accordance with the cell DRX or DTX cycles (code 1435). For example, the code 1435, when executed by processor 1320, may cause processor 1320 to cause transceiver 1330 to communicate with one or more TRPs, of the multiple TRPs, in accordance with the cell DRX or DTX cycles.

FIG. 14 is provided as an example. Other examples may differ from what is described in connection with FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150 may include a DRX and/or DTX component 1508, among other examples.

In some aspects, the apparatus 1500 may be configured to perform one or more operations described herein in connection with FIGS. 7-9. Additionally, or alternatively, the apparatus 1500 may be configured to perform one or more processes described herein, such as process 1100 of FIG. 11, or a combination thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The transmission component 1504 may transmit configuration information indicating cell DRX or DTX cycles for multiple TRPs. The cell DRX or DTX cycles may indicate inactive times and active times for the multiple TRPs. The reception component 1502 and/or the transmission component 1504 may communicate, via one or more TRPs of the multiple TRPs, in accordance with the cell DRX or DTX cycles. The DRX and/or DTX component 1508 may cause transitioning between an active state and an inactive state in accordance with a cell DRX or DTX cycle.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

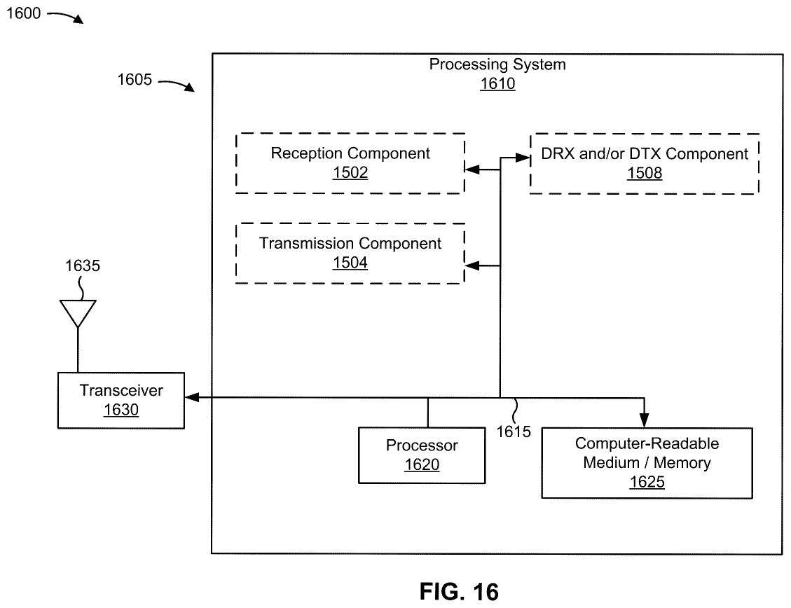

FIG. 16 is a diagram illustrating an example 1600 of a hardware implementation for an apparatus 1605 employing a processing system 1610, in accordance with the present disclosure. The apparatus 1605 may be a network node.

The processing system 1610 may be implemented with a bus architecture, represented generally by the bus 1615. The bus 1615 may include any number of interconnecting buses and bridges depending on the specific application of the processing system 1610 and the overall design constraints. The bus 1615 links together various circuits including one or more processors and/or hardware components, represented by the processor 1620, the illustrated components, and the computer-readable medium/memory 1625. The bus 1615 may also link various other circuits, such as timing sources, peripherals, voltage regulators, and/or power management circuits.

The processing system 1610 may be coupled to a transceiver 1630. The transceiver 1630 is coupled to one or more antennas 1635. The transceiver 1630 provides a means for communicating with various other apparatuses over a transmission medium. The transceiver 1630 receives a signal from the one or more antennas 1635, extracts information from the received signal, and provides the extracted information to the processing system 1610, specifically the reception component 1502. In addition, the transceiver 1630 receives information from the processing system 1610, specifically the transmission component 1504, and generates a signal to be applied to the one or more antennas 1635 based at least in part on the received information.

The processing system 1610 includes a processor 1620 coupled to a computer-readable medium/memory 1625. The processor 1620 is responsible for general processing, including the execution of software stored on the computer-readable medium/memory 1625. The software, when executed by the processor 1620, causes the processing system 1610 to perform the various functions described herein for any particular apparatus. The computer-readable medium/memory 1625 may also be used for storing data that is manipulated by the processor 1620 when executing software. The processing system further includes at least one of the illustrated components. The components may be software modules running in the processor 1620, resident/stored in the computer readable medium/memory 1625, one or more hardware modules coupled to the processor 1620, or some combination thereof.

In some aspects, the processing system 1610 may be a component of the base station 110 and may include the memory 242 and/or at least one of the TX MIMO processor 230, the receive processor 238, and/or the controller/processor 240. In some aspects, the apparatus 1605 for wireless communication includes means for transmitting configuration information indicating cell DRX or DTX cycles for multiple TRPs, the cell DRX or DTX cycles indicating inactive times and active times for the multiple TRPs; and/or means for communicating, via one or more TRPs of the multiple TRPs, in accordance with the cell DRX or DTX cycles. The aforementioned means may be one or more of the aforementioned components of the apparatus 1500 and/or the processing system 1610 of the apparatus 1605 configured to perform the functions recited by the aforementioned means. As described elsewhere herein, the processing system 1610 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 16 is provided as an example. Other examples may differ from what is described in connection with FIG. 16.

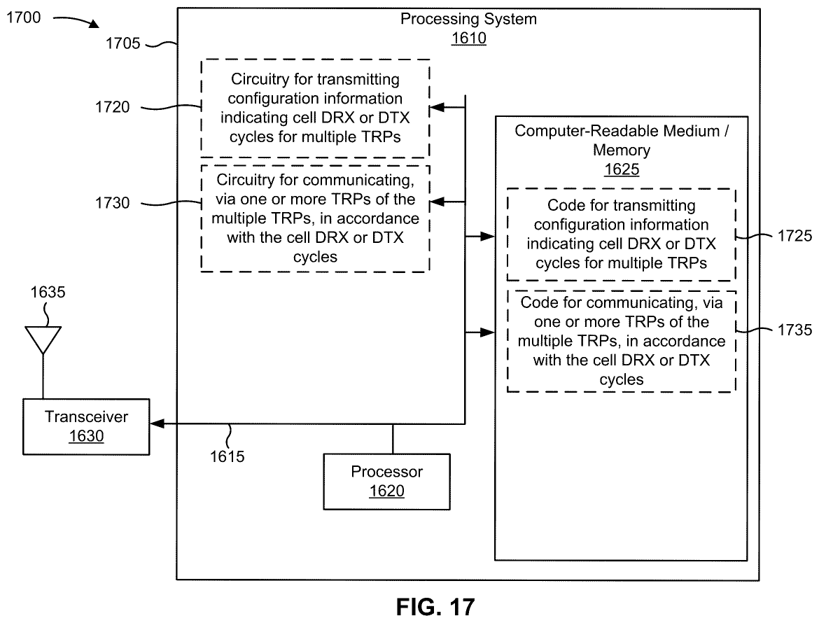

FIG. 17 is a diagram illustrating an example 1700 of an implementation of code and circuitry for an apparatus 1705, in accordance with the present disclosure. The apparatus 1705 may be a network node, or a network node may include the apparatus 1705.

As shown in FIG. 17, the apparatus 1705 may include circuitry for transmitting configuration information indicating cell DRX or DTX cycles for multiple TRPs (circuitry 1720). For example, the circuitry 1720 may enable the apparatus 1705 to transmit configuration information indicating cell DRX or DTX cycles for multiple TRPs. The cell DRX or DTX cycles may indicate inactive times and active times for the multiple TRPs.

As shown in FIG. 17, the apparatus 1705 may include, stored in computer-readable medium 1625, code for transmitting configuration information indicating cell DRX or DTX cycles for multiple TRPs (code 1725). For example, the code 1725, when executed by processor 1620, may cause processor 1620 to cause transceiver 1630 to transmit configuration information indicating cell DRX or DTX cycles for multiple TRPs.

As shown in FIG. 17, the apparatus 1705 may include circuitry for communicating, via one or more TRPs of the multiple TRPs, in accordance with the cell DRX or DTX cycles (circuitry 1730). For example, the circuitry 1730 may enable the apparatus 1705 to communicate, via one or more TRPs of the multiple TRPs, in accordance with the cell DRX or DTX cycles.

As shown in FIG. 17, the apparatus 1705 may include, stored in computer-readable medium 1625, code for communicating, via one or more TRPs of the multiple TRPs, in accordance with the cell DRX or DTX cycles (code 1735). For example, the code 1735, when executed by processor 1620, may cause processor 1620 to cause transceiver 1630 to communicate, via one or more TRPs of the multiple TRPs, in accordance with the cell DRX or DTX cycles.

FIG. 17 is provided as an example. Other examples may differ from what is described in connection with FIG. 17.

The following provides an overview of some Aspects of the present disclosure:

Aspect 1: A method of wireless communication performed at a user equipment (UE), comprising: receiving configuration information indicating cell discontinuous reception (DRX) or discontinuous transmission (DTX) cycles for multiple transmission reception points (TRPs), the cell DRX or DTX cycles indicating inactive times and active times for the multiple TRPs; and communicating with one or more TRPs, of the multiple TRPs, in accordance with the cell DRX or DTX cycles.

Aspect 2: The method of Aspect 1, wherein a first inactive time for a first TRP, of the multiple TRPs, is non-aligned in time with a second inactive time for a second TRP of the multiple TRPs.

Aspect 3: The method of any of Aspects 1-2, wherein communicating with the one or more TRPs comprises: dropping a communication associated with a TRP, of the multiple TRPs, during an inactive time for the TRP.

Aspect 4: The method of any of Aspects 1-2, wherein communicating with the one or more TRPs comprises: transferring a communication associated with a TRP, of the multiple TRPs, during an inactive time for the TRP, to another TRP, of the multiple TRPs, that is in an active time.

Aspect 5: The method of any of Aspects 1-4, wherein communicating with the one or more TRPs comprises: dropping or transferring a communication associated with a TRP, of the multiple TRPs, during an inactive time for the TRP, based on a type of physical channel or signal associated with the communication.

Aspect 6: The method of any of Aspects 1-5, wherein the configuration information indicates associations between the cell DRX or DTX cycles and the multiple TRPs using TRP indices.

Aspect 7: The method of any of Aspects 1-6, wherein the configuration information indicates associations between the cell DRX or DTX cycles and the multiple TRPs using control resource set pool indices.

Aspect 8: The method of any of Aspects 1-7, wherein the configuration information indicates associations between the cell DRX or DTX cycles and the multiple TRPs using transmission configuration indicator states.

Aspect 9: The method of any of Aspects 1-8, wherein the configuration information indicates a single DRX or DTX cycle that is for a TRP, of the multiple TRPs, and a DRX or DTX cycle for another TRP, of the multiple TRPs, is an inverse of the single DRX or DTX cycle.

Aspect 10: The method of any of Aspects 1-3 or 5-9, wherein communicating with the one or more TRPs comprises: dropping an uplink communication associated with a TRP, of the multiple TRPs, during an inactive time for the TRP.

Aspect 11: The method of any of Aspects 1-2 or 4-9, wherein communicating with the one or more TRPs comprises: transmitting an uplink communication associated with a TRP, of the multiple TRPs, during an inactive time of the TRP, to another TRP, of the multiple TRPs, that is in an active time.

Aspect 12: The method of any of Aspects 1-3 or 5-10, wherein communicating with the one or more TRPs comprises: dropping a sounding reference signal communication associated with a TRP, of the multiple TRPs, during an inactive time of the TRP.

Aspect 13: The method of any of Aspects 1-2 or 6-9, wherein communicating with the one or more TRPs comprises: transmitting a sounding reference signal communication associated with a TRP, of the multiple TRPs, to the TRP, during an inactive time of the TRP.

Aspect 14: A method of wireless communication performed at a network node, comprising: transmitting configuration information indicating cell discontinuous reception (DRX) or discontinuous transmission (DTX) cycles for multiple transmission reception points (TRPs), the cell DRX or DTX cycles indicating inactive times and active times for the multiple TRPs; and communicating, via one or more TRPs of the multiple TRPs, in accordance with the cell DRX or DTX cycles.

Aspect 15: The method of Aspect 14, wherein a first inactive time for a first TRP, of the multiple TRPs, is non-aligned in time with a second inactive time for a second TRP of the multiple TRPs.

Aspect 16: The method of any of Aspects 14-15, wherein communicating via the one or more TRPs comprises: dropping a communication associated with a TRP, of the multiple TRPs, during an inactive time for the TRP.

Aspect 17: The method of any of Aspects 14-15, wherein communicating via the one or more TRPs comprises: transferring a communication associated with a TRP, of the multiple TRPs, during an inactive time for the TRP, to another TRP, of the multiple TRPs, that is in an active time.

Aspect 18: The method of any of Aspects 14-17, wherein communicating via the one or more TRPs comprises: dropping or transferring a communication associated with a TRP, of the multiple TRPs, during an inactive time for the TRP, based on a type of physical channel or signal associated with the communication.

Aspect 19: The method of any of Aspects 14-18, wherein the configuration information indicates associations between the cell DRX or DTX cycles and the multiple TRPs using TRP indices.

Aspect 20: The method of any of Aspects 14-19, wherein the configuration information indicates associations between the cell DRX or DTX cycles and the multiple TRPs using control resource set pool indices.

Aspect 21: The method of any of Aspects 14-20, wherein the configuration information indicates associations between the cell DRX or DTX cycles and the multiple TRPs using transmission configuration indicator states.

Aspect 22: The method of any of Aspects 14-21, wherein the configuration information indicates a single DRX or DTX cycle that is for a TRP, of the multiple TRPs, and a DRX or DTX cycle for another TRP, of the multiple TRPs, is an inverse of the single DRX or DTX cycle.

Aspect 23: The method of any of Aspects 14-16 or 18-22, wherein communicating via the one or more TRPs comprises: dropping an uplink communication associated with a TRP, of the multiple TRPs, during an inactive time for the TRP.

Aspect 24: The method of any of Aspects 14-15 or 17-22, wherein communicating via the one or more TRPs comprises: receiving an uplink communication associated with a TRP, of the multiple TRPs, during an inactive time of the TRP via another TRP, of the multiple TRPs, that is in an active time.

Aspect 25: The method of any of Aspects 14-16 or 18-23, wherein communicating via the one or more TRPs comprises: dropping a sounding reference signal communication associated with a TRP, of the multiple TRPs, during an inactive time of the TRP.

Aspect 26: The method of any of Aspects 14-15 or 19-22, wherein communicating via the one or more TRPs comprises: receiving a sounding reference signal communication associated with a TRP, of the multiple TRPs, via the TRP, during an inactive time of the TRP.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the 0097-4713 43 like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories storing processor-executable code; and
one or more processors coupled with the one or more memories and individually or collectively operable to:
receive configuration information indicating cell discontinuous reception (DRX) or discontinuous transmission (DTX) cycles for multiple transmission reception points (TRPs), the cell DRX or DTX cycles indicating inactive times and active times for the multiple TRPs; and
communicate with one or more TRPs, of the multiple TRPs, in accordance with the cell DRX or DTX cycles.

2. The apparatus of claim 1, wherein a first inactive time for a first TRP, of the multiple TRPs, is non-aligned in time with a second inactive time for a second TRP of the multiple TRPs.

3. The apparatus of claim 1, wherein, to communicate with the one or more TRPs, the one or more processors are individually or collectively operable to:
drop a communication associated with a TRP, of the multiple TRPs, during an inactive time for the TRP.

4. The apparatus of claim 1, wherein, to communicate with the one or more TRPs, the one or more processors are individually or collectively operable to:
transfer a communication associated with a TRP, of the multiple TRPs, during an inactive time for the TRP, to another TRP, of the multiple TRPs, that is in an active time.

5. The apparatus of claim 1, wherein, to communicate with the one or more TRPs, the one or more processors are individually or collectively operable to:
drop or transfer a communication associated with a TRP, of the multiple TRPs, during an inactive time for the TRP, based on a type of physical channel or signal associated with the communication.

6. The apparatus of claim 1, wherein the configuration information indicates associations between the cell DRX or DTX cycles and the multiple TRPs using TRP indices.

7. The apparatus of claim 1, wherein the configuration information indicates associations between the cell DRX or DTX cycles and the multiple TRPs using control resource set pool indices.

8. The apparatus of claim 1, wherein the configuration information indicates associations between the cell DRX or DTX cycles and the multiple TRPs using transmission configuration indicator states.

9. The apparatus of claim 1, wherein the configuration information indicates a single DRX or DTX cycle that is for a TRP, of the multiple TRPs, and a DRX or DTX cycle for another TRP, of the multiple TRPs, is an inverse of the single DRX or DTX cycle.

10. The apparatus of claim 1, wherein, to communicate with the one or more TRPs, the one or more processors are individually or collectively operable to:
drop an uplink communication associated with a TRP, of the multiple TRPs, during an inactive time for the TRP.

11. The apparatus of claim 1, wherein, to communicate with the one or more TRPs, the one or more processors are individually or collectively operable to:
transmit an uplink communication associated with a TRP, of the multiple TRPs, during an inactive time of the TRP, to another TRP, of the multiple TRPs, that is in an active time.

12. The apparatus of claim 1, wherein, to communicate with the one or more TRPs, the one or more processors are individually or collectively operable to:
drop a sounding reference signal communication associated with a TRP, of the multiple TRPs, during an inactive time of the TRP.

13. The apparatus of claim 1, wherein, to communicate with the one or more TRPs, the one or more processors are individually or collectively operable to:
transmit a sounding reference signal communication associated with a TRP, of the multiple TRPs, to the TRP, during an inactive time of the TRP.

14. An apparatus for wireless communication at a network node, comprising:
one or more memories storing processor-executable code; and
one or more processors coupled with the one or more memories and individually or collectively operable to:
transmit configuration information indicating cell discontinuous reception (DRX) or discontinuous transmission (DTX) cycles for multiple transmission reception points (TRPs), the cell DRX or DTX cycles indicating inactive times and active times for the multiple TRPs; and
communicate, via one or more TRPs of the multiple TRPs, in accordance with the cell DRX or DTX cycles.

15. The apparatus of claim 14, wherein a first inactive time for a first TRP, of the multiple TRPs, is non-aligned in time with a second inactive time for a second TRP of the multiple TRPs.

16. The apparatus of claim 14, wherein, to communicate via the one or more TRPs, the one or more processors are individually or collectively operable to:
drop a communication associated with a TRP, of the multiple TRPs, during an inactive time for the TRP.

17. The apparatus of claim 14, wherein, to communicate via the one or more TRPs, the one or more processors are individually or collectively operable to:
transfer a communication associated with a TRP, of the multiple TRPs, during an inactive time for the TRP, to another TRP, of the multiple TRPs, that is in an active time.

18. The apparatus of claim 14, wherein, to communicate via the one or more TRPs, the one or more processors are individually or collectively operable to:
drop or transfer a communication associated with a TRP, of the multiple TRPs, during an inactive time for the TRP, based on a type of physical channel or signal associated with the communication.

19. The apparatus of claim 14, wherein the configuration information indicates associations between the cell DRX or DTX cycles and the multiple TRPs using TRP indices.

20. The apparatus of claim 14, wherein the configuration information indicates associations between the cell DRX or DTX cycles and the multiple TRPs using control resource set pool indices.

21. The apparatus of claim 14, wherein the configuration information indicates associations between the cell DRX or DTX cycles and the multiple TRPs using transmission configuration indicator states.

22. The apparatus of claim 14, wherein the configuration information indicates a single DRX or DTX cycle that is for a TRP, of the multiple TRPs, and a DRX or DTX cycle for another TRP, of the multiple TRPs, is an inverse of the single DRX or DTX cycle.

23. The apparatus of claim 14, wherein, to communicate via the one or more TRPs, the one or more processors are individually or collectively operable to:
drop an uplink communication associated with a TRP, of the multiple TRPs, during an inactive time for the TRP.

24. The apparatus of claim 14, wherein, to communicate via the one or more TRPs, the one or more processors are individually or collectively operable to:
receive an uplink communication associated with a TRP, of the multiple TRPs, during an inactive time of the TRP via another TRP, of the multiple TRPs, that is in an active time.

25. The apparatus of claim 14, wherein, to communicate via the one or more TRPs, the one or more processors are individually or collectively operable to:
drop a sounding reference signal communication associated with a TRP, of the multiple TRPs, during an inactive time of the TRP.

26. The apparatus of claim 14, wherein, to communicate via the one or more TRPs, the one or more processors are individually or collectively operable to:
receive a sounding reference signal communication associated with a TRP, of the multiple TRPs, via the TRP, during an inactive time of the TRP.

27. A method of wireless communication performed at a user equipment (UE), comprising:
receiving configuration information indicating cell discontinuous reception (DRX) or discontinuous transmission (DTX) cycles for multiple transmission reception points (TRPs), the cell DRX or DTX cycles indicating inactive times and active times for the multiple TRPs; and
communicating with one or more TRPs, of the multiple TRPs, in accordance with the cell DRX or DTX cycles.

28. The method of claim 27, wherein a first inactive time for a first TRP, of the multiple TRPs, is non-aligned in time with a second inactive time for a second TRP of the multiple TRPs.

29. A method of wireless communication performed at a network node, comprising:
transmitting configuration information indicating cell discontinuous reception (DRX) or discontinuous transmission (DTX) cycles for multiple transmission reception points (TRPs), the cell DRX or DTX cycles indicating inactive times and active times for the multiple TRPs; and
communicating, via one or more TRPs of the multiple TRPs, in accordance with the cell DRX or DTX cycles.

30. The method of claim 29, wherein a first inactive time for a first TRP, of the multiple TRPs, is non-aligned in time with a second inactive time for a second TRP of the multiple TRPs.
